(19) United States
(12) Patent Application Publication
(10) Pub. No.: US 2011/0193774 A1
(43) Pub. Date: Aug. 11, 2011

(54) INFORMATION PROCESSING DEVICE

(76) Inventors: Mayumi NAKADE, Yokohama (JP); Takahiko Nozoe, Yokohama (JP); Yukinori Asada, Chigasaki (JP); Hidenori Sakaniwa, Yokohama (JP)

(21) Appl. No.: 12/912,908

(22) Filed: Oct. 27, 2010

(30) Foreign Application Priority Data
Feb. 8, 2010 (JP) 2010-024994

(51) Int. Cl. G09G 5/00

(52) U.S. Cl. 345/156

(57) ABSTRACT

In an operation control device for controlling the operation of an appliance such as television receiver, a human-perceiving sensor is used as a unit for detecting movements of the operator. Then, continuous movements are extracted therefrom, such as hand-waving movements performed by the operator with an intention of operating the appliance such as television receiver. Moreover, if the operator performs one and the same movement during a time-period which is longer than a certain constant time-period, a control determined in advance is exerted over the operation control device. Also, the situation in which the movements of the operator are detected is displayed on the appliance such as television receiver, so that the operator is permitted to perform a more accurate movement by the resultant feedback effect.

### INCORPORATION BY REFERENCE

The present application claims priority from Japanese application JP2010-024994 filed on Feb. 8, 2010, the content of which is hereby incorporated by reference into this application.

### BACKGROUND OF THE INVENTION

The present invention relates to the operation of each type of information processing device such as a television receiver.

Television receivers in recent years are generally configured such that the television receiver is operated using a remote control device, i.e., the so-called remote control, for controlling the television receiver from a place away from the receiver.

In JP-A-2004-356819, an object is “to provide a remote control device which allows the execution of a remote operation of an AV appliance such as a television receiver even if the remote control is not at hand, or even if the remote control is lost, and allows the operator to recognize whether or not the AV appliance has accepted the operation even in the course of the operation” (refer to [0007] in JP-A-2004-356819). Moreover, as a solving unit for the problem, there is disclosed a configuration of “including a photographing unit, a movement detection unit for detecting a movement of an image photographed by the photographing unit, a movement-portion extraction unit for extracting, from the detected image, a portion of the image in which the movement is present, an image recognition unit for recognizing a predetermined movement and/or shape from the extracted portion of the image, a display unit for displaying a selection menu including an alternative image pattern for permitting the operator to select operation contents, a judgment unit for judging whether or not the image recognition result and the alternative image pattern displayed on the selection menu are in a correspondence relationship with each other, and a control unit for executing the operation contents based on the judgment result” (refer to [0008] in JP-A-2004-356819).

Also, in JP-A-2007-96462, an object is “to provide a human-perceiving-sensor-function-equipped AV appliance which allows the accomplishment of a fine-grained power-saving effect by mounting a human-perceiving sensor onto an AV appliance such as a television receiver, and preparing a normal mode and a power-saving mode therefor, and exerting the human-perceiving sensor's function in each mode” (refer to [0007] in JP-A-2007-96462). Moreover, as a unit for achieving the object, the unit has the human-perceiving-sensor-function-equipped AV appliance onto which the human-perceiving sensor for perceiving the presence of a human is set up, and for which the normal mode and the power-saving mode are provided, a power-supply being able to be manually turned OFF in the normal mode, and the power-saving effect being able to be exhibited in the power-saving mode, in which the unit is configured such that, when the power-saving mode is set, the power-saving mode is automatically switched into a standby mode if the human-perceiving sensor cannot detect the presence of a human for a predetermined time, the power-supply then being automatically turned OFF if a predetermined time for the standby mode has elapsed” (refer to [0008] in JP-A-2007-96462).

### SUMMARY OF THE INVENTION

The remote control is a convenient device which makes it possible to control a television receiver from a place away from the receiver. It turns out, however, that the operator feels stress if the remote control is in an unusable state. An example of the unusable state is that the remote control is not at hand, or that its battery is exhausted.

In JP-A-2004-356819, as an improving countermeasure for this problem, the proposal has been made concerning the scheme whereby the appliance is operated by detecting the shape or movement of a hand of the operator. Also, in JP-A-2007-96462, the proposal has been made regarding the AV appliance which is equipped with the human-perceiving sensor.

In the invention disclosed in JP-A-2004-356819, however, it is required to install, onto the television receiver, a camera, and a high-performance CPU and a high-capacity memory for applying an image processing to output data from the camera. As a result, there exists a problem that the television receiver becomes a high-cost television receiver.

The human-perceiving sensor is less expensive than the camera, but the device using the human-perceiving sensor disclosed by JP-A-2007-96462 judges only two-value states, i.e., the presence or absence of a human. As a result, it is impossible to implement the operation of the television receiver based on an intentional movement of the operator.

In order to solve the above-described problem, an aspect of an embodiment of the present invention is as follows: Namely, there is provided, for example, an information processing device including a movement detection unit which detects a movement of a user, and a movement analysis unit which analyzes a detection result by the movement detection unit, wherein the movement analysis unit analyzes an elapsed-time change in the movement of the user detected by the movement detection unit, and performs a predetermined processing to the information processing device if the elapsed-time change in the movement of the user has exceeded a predetermined threshold value.

According to the above-described unit, it becomes possible to provide the device that is less expensive, is superior in the operability, and is easy to use from the user's standpoint.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram for illustrating an example of the configuration of an operation control device in a first embodiment;

FIG. 2 illustrates an activation example of the operation control device in the first embodiment;

FIG. 3A illustrates an example of the output-voltage level from a movement detection unit in the first embodiment;

FIG. 3B illustrates an example of the output-voltage level from the movement detection unit in the first embodiment;

FIG. 4 illustrates an example of the output-voltage level from the movement detection unit in the first embodiment;

FIG. 5 illustrates an example of the processing flow of the operation control device in the first embodiment;

FIG. 6 illustrates an activation example of the operation control device in a second embodiment;

FIG. 7 illustrates an example of the configuration of the operation control device in the second embodiment;

FIG. 8 illustrates an example of the output-voltage level from the movement detection unit in the second embodiment;

FIG. 9 illustrates an example of the processing flow of the operation control device in a third embodiment;

FIG. 10 illustrates an example of the output-voltage level from the movement detection unit in the third embodiment;

FIG. 11 illustrates an example of the processing flow of the operation control device in the third embodiment;

FIGS. 12A-12E illustrate examples of the display picture in the third embodiment;

FIG. 13 illustrates an example of the processing flow of the operation control device in a fourth embodiment;

FIG. 14 illustrates an example of the display picture in the fourth embodiment; and

FIG. 15 illustrates an example of the display picture in the fourth embodiment.

### DESCRIPTION OF THE INVENTION

Hereinafter, referring to the drawings, the explanation will be given below concerning embodiments of the present invention.

### Embodiment 1

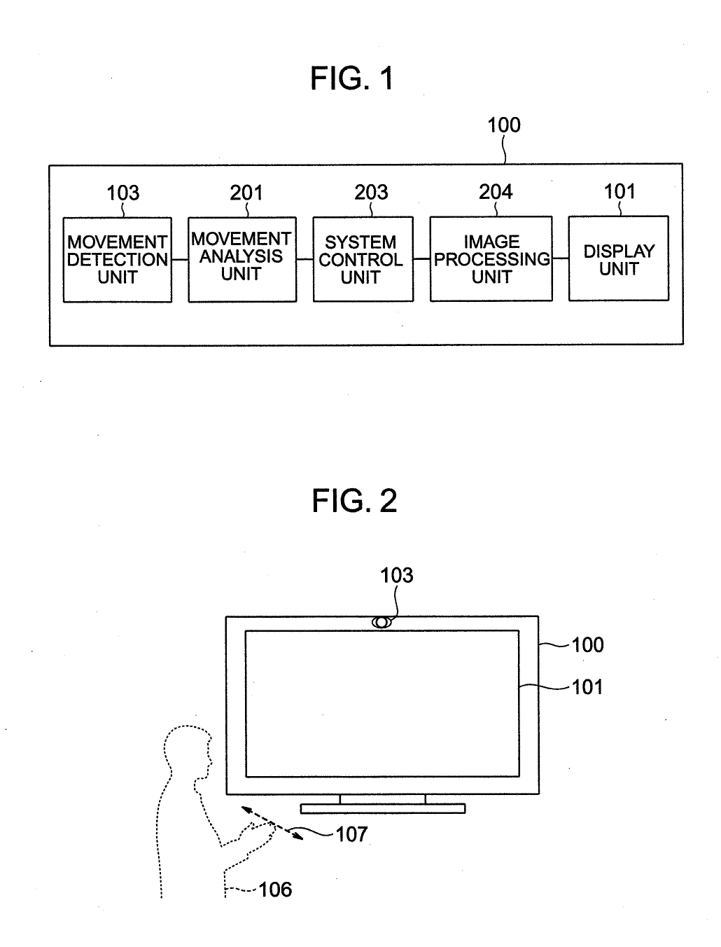

FIG. 1 is a block diagram for illustrating an example of the configuration of an operation control device in the present embodiment. Reference numerals in FIG. 1 denote the following components, respectively: 100 denotes the operation control device. 103 denotes a movement detection unit constituted with a human-perceiving sensor (such as a pyroelectric infrared-rays sensor) which detects a change in amount of the heat radiation emitted from a heat source such as a human, and thereby outputs a voltage corresponding to a movement of the heat source. 201 denotes a movement analysis unit which fetches the output voltage outputted from the movement detection unit 103 with a certain constant time-period placed, and analyzes, from the data fetched, factors such as the amplitude and period of the output voltage outputted from the movement detection unit 103, and detects, from the analysis result, if the operator is doing a certain constant movement. 203 denotes a system control unit which controls the operation control device 100 on the basis of the analysis result obtained by the movement analysis unit 201. 204 denotes an image processing unit controlled by the system control unit 203 thereby to generate image data. 101 denotes a display unit which displays a picture generated by the image processing unit 204. The display unit 101 is constituted with a display unit such as, e.g., a liquid-crystal display or plasma display.

FIG. 2 illustrates a control conceptual diagram of the operation control device 100 in the present embodiment. The same reference numerals are allocated to the same components as the ones in FIG. 1. A reference numeral 106 denotes the operator of the operation control device 100. A numeral 107 denotes the trajectory of a hand at the time when the operator 106 moves his or her hand with an intention of operating the operation control device 100. The movement of the operator 106 is detected by the movement detection unit 103.

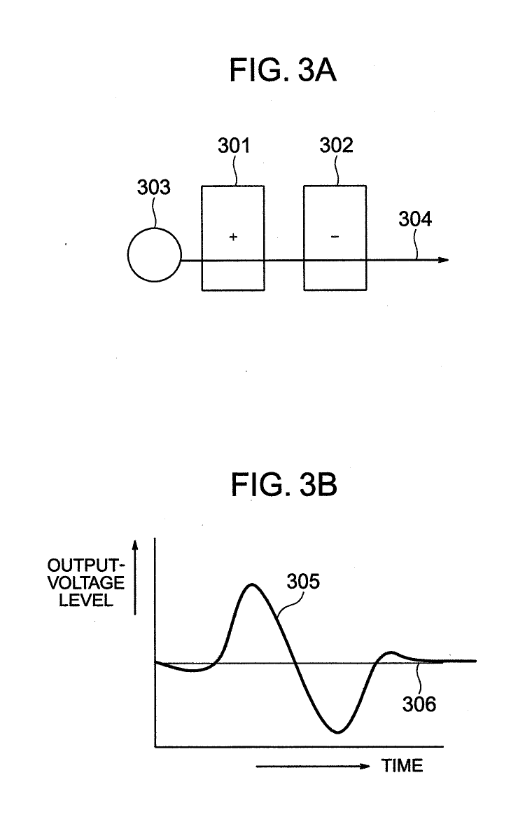

FIG. 3A and FIG. 3B illustrate an example of heat-source detection areas and an example of the output voltage in the case where the pyroelectric infrared-rays sensor is used as the movement detection unit 103. FIG. 3A illustrates the example where two units of heat-source detection elements are used as the movement detection unit 103 (this example is also referred to as “dual type”).

Numerals 301 and 302 denote the heat-source detection areas of the movement detection unit 103. If the heat-radiation amount in each heat-source detection area increases, positive electric charges are generated in the heat-source detection area 301; whereas, negative electric charges are generated in the heat-source detection area 302. Electric charges, which result from combining the positive electric charges in the heat-source detection area 301 and the negative electric charges in the heat-source detection area 302, are converted into the voltage, then being outputted by the movement detection unit 103.

A numeral 303 denotes the heat source, and a numeral 304 denotes a movement of the heat source. FIG. 3B illustrates an example of the output waveform of the movement detection unit 103 in the case where the heat source 303 has moved as is represented by the movement 304. A vertical axis in FIG. 3B denotes the output-voltage level from the movement detection unit 103, and a transverse axis therein denotes time lapse.

A numeral 305 denotes an example of the output waveform which indicates a change in the output-voltage level from the movement detection unit 103 in the case where the heat source 303 has moved as is represented by the movement 304. A numeral 306 denotes the output-voltage level from the movement detection unit 103 in a case where the movement of the heat source is not detected. When the heat source 303 has entered the heat-source detection area 301, the output-voltage level from the movement detection unit 103 becomes larger. Moreover, when the heat source 303 has left the heat-source detection area 301, the output-voltage level from the movement detection unit 103 becomes smaller.

Next, when the heat source 303 has entered the heat-source detection area 302, the output-voltage level from the movement detection unit 103 becomes even smaller. Furthermore, as the heat source 303 is gradually leaving the heat-source detection area 302, the output-voltage level from the movement detection unit 103 is gradually becoming larger. In a case where no change is found in the heat-radiation amount in each heat-source detection area, such that the heat source 303 exists outside each heat-source detection area, or the heat source 303 does not move, the movement detection unit 103 outputs a voltage which is at substantially the output-voltage level 306. As having been explained so far, the movement detection unit 103 makes it possible to detect a movement of the heat source including a movement of the human.

Here, the output-voltage level from the movement detection unit 103 changes depending on such factors as the size, temperature, and displacement amount of a moving heat source, the heat-source detection area through which the heat source is moving, and a temperature difference between the moving heat source and the peripheral environment. Accordingly, in a general living environment, basically the same movements of a heat source do not necessarily results in the same output.

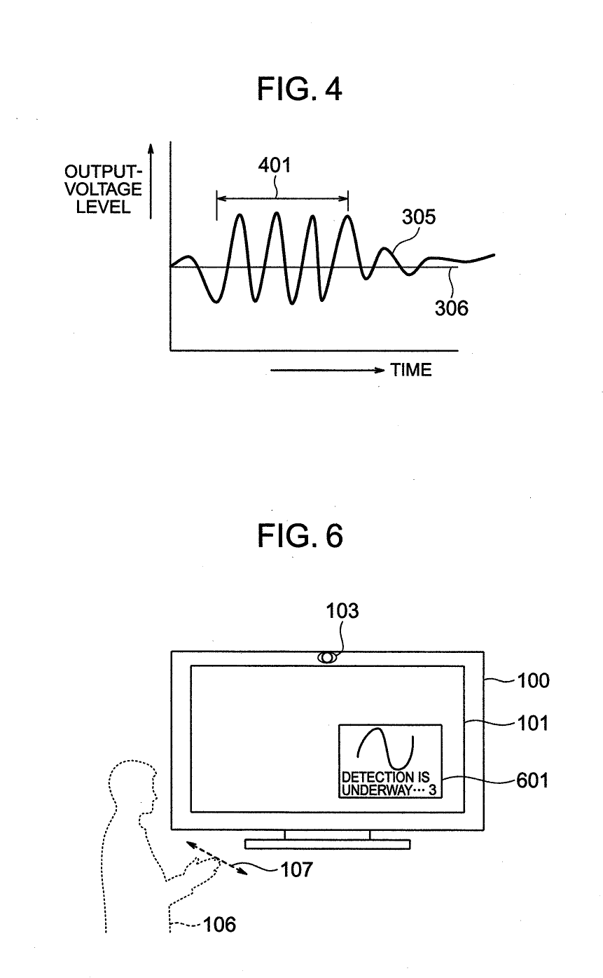

Nevertheless, the movement detection unit 103 generates similar output level with respect to basically the same movements of a single heat source within a short time-period. For example, if the operator is waving his or her hand continuously, the movement detection unit 103 outputs an output waveform whose amplitude and period remain substantially coherent (as is indicated by the waveform inside a time-interval 401 illustrated in FIG. 4). In FIG. 4, the same reference numerals are allocated to the same components as the ones in FIG. 3, and thus the explanation thereof will be omitted.

The movement analysis unit 201 analyzes the output-voltage waveform 305 of the movement detection unit 103. Then, if the unit 201 has extracted a waveform, whose amplitude and period fall inside a certain constant range (as is indicated by the time-interval 401), at the number-of-times that is larger than a certain reference number-of-times, the unit 201 regards the operator as having done a movement for intending some control. Furthermore, the movement analysis unit 201 issues a notice to the effect to the system control unit 203.

Having received the notice from the movement analysis unit 201, the system control unit 203 performs a control which is registered in advance. The control executable at this time is as follows, for example: In the operation control device 100, if the power-supply of the display unit 101 lies in an OFF state, the power-supply of the display unit 101 is switched into an ON state on the basis of the notice from the movement analysis unit 201. Otherwise, in the operation control device 100, if the power-supply of the display unit 101 lies in the ON state, the power-supply of the display unit 101 is switched into the OFF state on the basis of the notice from the movement analysis unit 201.

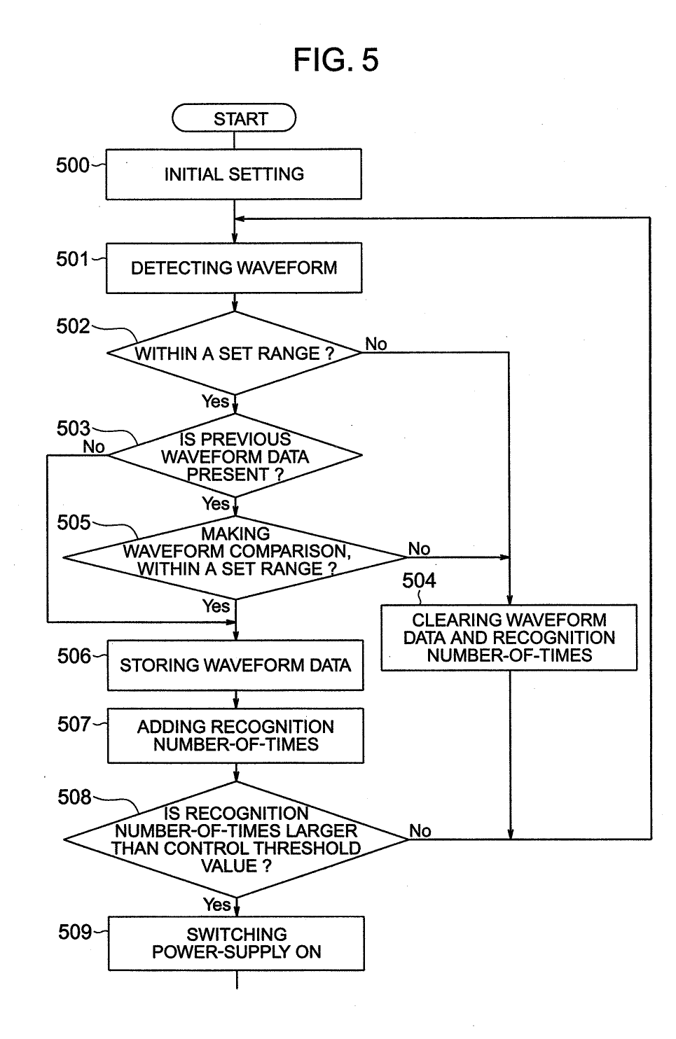

Hereinafter, referring to a processing flow diagram in FIG. 5, the explanation will be given below concerning an example of the operation in the case where the power-supply of the display unit 101 of the operation control device 100 is switched ON by a movement of the operator.

First, a step 500 is an initial setting, where stored data such as recognition number-of-times and waveform data are cleared or initialized. At a step 501, the amplitude and period of the output-voltage waveform 305 are detected.

At a step 502, if the amplitude and period of the output-voltage waveform detected by the movement analysis unit 201 fall inside a certain constant range set in advance, the operation proceeds to a step 503. Meanwhile, if the amplitude and period of the output-voltage waveform fall outside the constant range set in advance, the operation proceeds to a step 504. At the step 504, stored waveform data and recognition number-of-times are cleared if they are present, then making the analysis of the next waveform.

At the step 503, it is judged whether the previous waveform data stored is present or absent. Then, if the previous waveform data is present, the operation proceeds to a step 505. If not, the operation proceeds to a step 506. At the step 505, a comparison is made between the output-voltage waveform and the previous waveform data stored. Then, if the amplitude and frequency of the waveform data fall inside a certain set range, the operation proceeds to the step 506. Meanwhile, if the amplitude and frequency fall outside the set range, the operation proceeds to the step 504.

At the step 506, the amplitude and frequency of the waveform data are stored. Incidentally, further, in addition to the relative comparison with the waveform data stored, the following judgment processing is also executable as the judgment processing as to whether the amplitude and frequency of the waveform data fall inside or outside the range of the set value: Namely, criterions for the absolute values of the amplitude and frequency to be recognized are set. Then, based on the comparison with the criterions for the absolute values, it is judged whether or not the waveform is a waveform of a continuous movement. The execution of this judgment processing makes it possible to reduce the occurrence of a false recognition.

At a step 507, the recognition number-of-times recognized as the waveform is added. At a step 508, if the recognition number-of-times is smaller than a certain constant value, the next waveform is fetched, then continuing the analysis. Meanwhile, if the recognition number-of-times has exceeded the constant value, the operation proceeds to a step 509, where the power-supply of the display unit 101 is switched ON.

Here, the recognition number-of-times is defined as the number of peaks on the positive and negative sides of a waveform. Accordingly, it turns out that, when the control threshold value is set at eight, the power-supply of the display unit 101 is switched ON at the eighth peak of the output-voltage waveform inside the time-interval 401.

The processing flow explained so far allows the power-supply of the display unit 101 of the operation control device 100 to be switched ON using the output of the movement detection unit 103.

Incidentally, in the above-described example of the processing flow, the explanation has been given regarding the processing flow for switching the power-supply of the display unit 1010N. Switching the power-supply OFF, however, can also be performed in accordance with basically the same way by managing the power-supply activation state. Moreover, in the case other than the power-supply OFF, i.e., at the time of the power-supply ON, it becomes possible to perform a plurality of controls on the basis of the same movement by performing an operation such as switching the display/non-display of the menu picture.

Also, a control item which is to be controlled is selected and set in advance by each operator. This scheme allows a favorite control item on each operator basis to be controlled by doing a movement such as hand-waving or gesture.

Incidentally, the explanation has been given regarding the case where the dual-type heat-source detection elements are used as the example of the detection elements of the movement detection unit 103. It is conceivable similarly, however, that a movement detection unit is employed where the one unit of heat-source detection element is used, or where the three or more units of heat-source detection elements are used. Also, although not explained with the use of the illustration, in the movement detection unit 103, a lens which is suitable for a detection distance and detection angle is used in a manner of being attached on the movement detection unit 103. This lens is attached in order to implement a wide range of heat-source detection, or in order to detect movements in a plurality of heat-source detection areas.

As having been explained so far, in the operation control device in the present embodiment, the heat-source detection elements are used which are less expensive than the camera. Even if the remote control is not at hand of the user, this feature permits the control for the operation control device to be executed by the user's doing a certain continuous movement.

### Embodiment 2

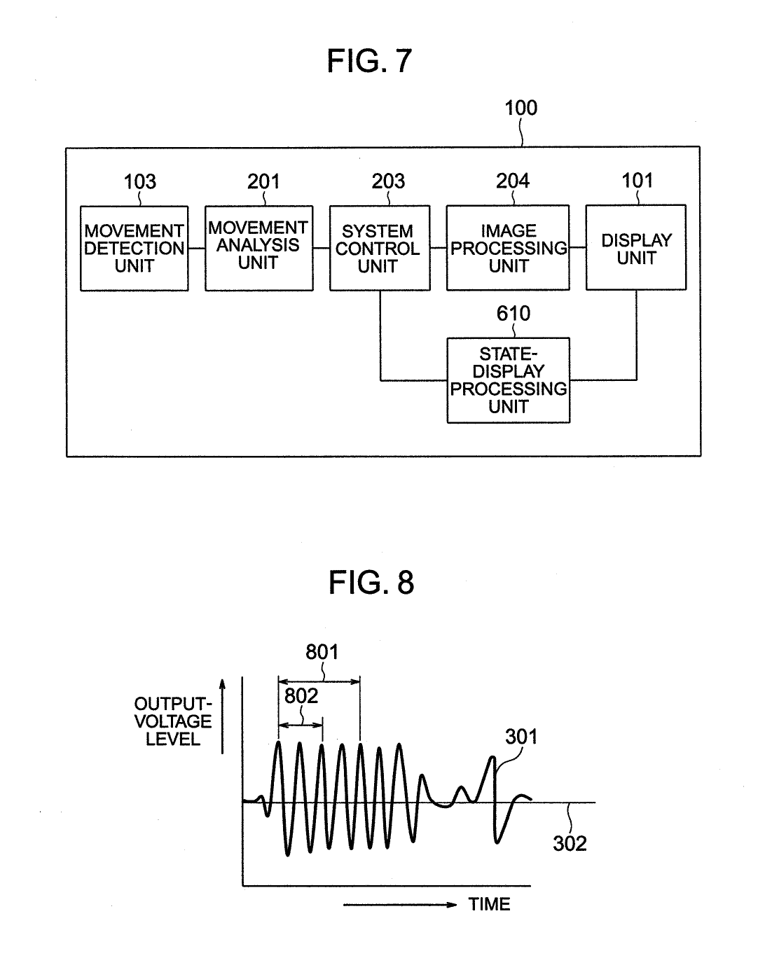

FIG. 6 illustrates an activation example of the operation control device in the present embodiment. FIG. 7 illustrates an example of the configuration of the operation control device. The same reference numerals are allocated to the same components as the ones in FIG. 1 and FIG. 2, and thus the explanation thereof will be omitted.

A reference numeral 601 denotes a movement-detection-situation display area which is to be displayed on the display unit 101. This display area displays the output of the movement detection unit 103 or the analysis result of the movement analysis unit 201 (which, hereinafter, will be also referred to as “detection situation”) at the time when a certain constant movement of the operator is detected. Namely, the numeral 610 denotes a state-display processing unit for performing the processing whereby, based on an instruction from the system control unit 203, the output of the movement detection unit 103 or the analysis result of the movement analysis unit 201 is displayed on the display unit 101 as the movement-detection-situation display area.

The state-display processing unit 610 performs the processing of displaying the detection situation on, e.g., a LED panel or liquid-crystal display on which a partial display control is executable. For example, the unit 610 displays the detection situation using a display on which a partial display by the backlight (such as, e.g., LED backlight) is controllable.

FIG. 8 illustrates an example of the output-voltage waveform of the movement detection unit. The same reference numerals are allocated to the same components as the ones in FIG. 3A, FIG. 3B, and FIG. 4, and thus the explanation thereof will be omitted. A time-interval 801 indicates the number of the waveforms which are needed for controlling the operation control device 100. A time-interval 802 indicates the number of the waveforms which are needed for displaying the display screen 601.

When controlling the operation control device 100, when, e.g., the waveform number inside the time-interval 801 is defined as the control threshold value, if the output waveform number has exceeded the waveform number inside the time-interval 802 that includes a waveform number which is smaller than the waveform number inside the time-interval 801, factors such as the recognized waveform number, waveform amplitudes, or waveforms are displayed on the area denoted by 601.

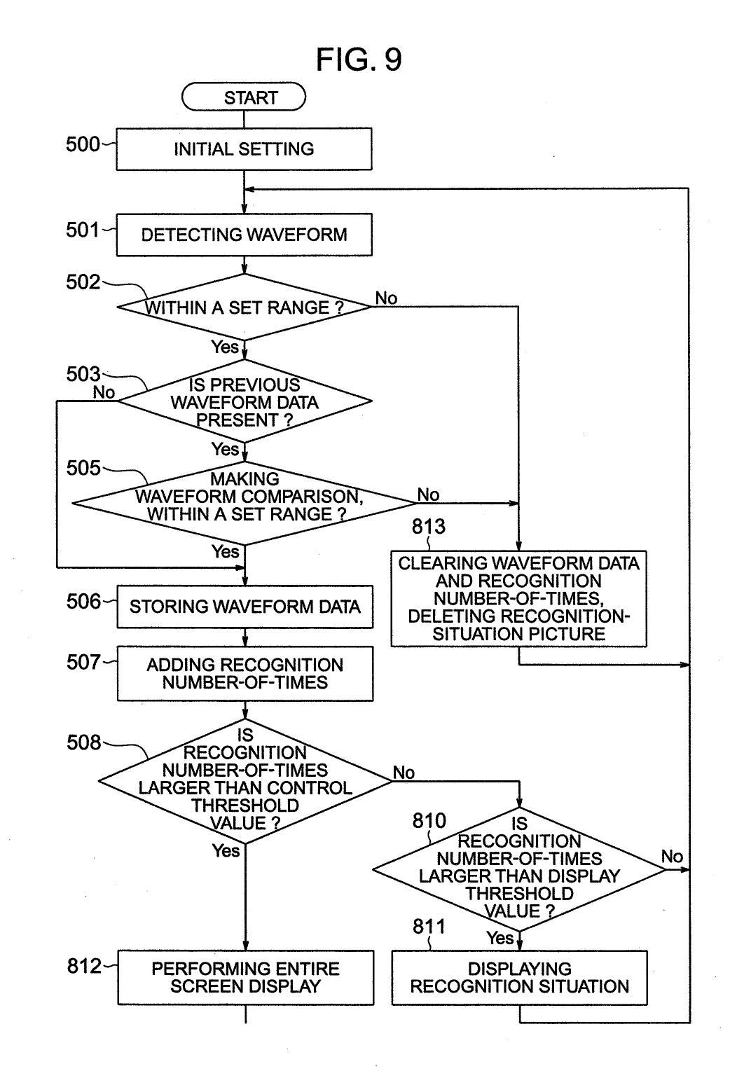

Next, referring FIG. 9, the explanation will be given below concerning a processing flow for displaying the movement-detection-situation display area 601. The same reference numerals are allocated to the same components as the ones in FIG. 5, and thus the explanation thereof will be omitted. At the step 508, if the recognition number-of-times is smaller than the control threshold value (if the recognition number-of-times has exceeded this control threshold value, a predetermined control (e.g., the power-supply is switched ON) is exerted over the device 100), the operation proceeds to a step 810. At the step 810, if, although the recognition number-of-times is smaller than the control threshold value, the recognition number-of-times is found to be larger than a display threshold value (which is a value smaller than the control threshold value, and the display area 601 is displayed if the recognition number-of-times has exceeded this display threshold value), the movement detection situation is displayed on the display unit 101 at a step 811. When the operator has confirmed the recognition situation displayed, and further, continues a movement such as waving his or her hand, it is judged at the step 508 that the recognition number-of-times becomes larger than the control threshold value. Then, at a step 812, a predetermined control (e.g., the display using the entire screen of the display unit 101) is performed.

As explained above, the operator is notified of the recognition situation. This feature permits the operator to understand that his or her movement is recognized by the operation control device 100. Accordingly, the operator recognizes that he or she will be able to control the operation control device 100 by continuing the same movement with no change added thereto. On account of this feature, even if the control threshold value is set at a longer value in order to prevent a false operation caused by a false detection, the operator can repeat the same movement without any worry and anxiety.

Incidentally, in the above-described operation control device 100, the explanation has been given selecting the power-supply-ON operation as the example. In the power-supply-OFF operation or some other operations, however, basically the same effect can also be obtained by notifying the operator of the recognition situation. Also, the notification of the recognition situation is displayed in such a manner that the partial area of the display screen is used. This feature makes it possible to reduce the power consumption as compared with the case where the entire display screen is used.

Moreover, in the movement detection unit 103, the position relationship between the infrared-rays detection elements and the lens gives rise to the occurrence of a location where the sensitivity is high and the occurrence of a location where the sensitivity is low. On account of this phenomenon, even if the operator is doing one and the same movement, the location where the operation control device 100 is easy to control and the location where the operation control device 100 is difficult to control are caused to occur, depending on a location through which the operator is moving now. Then, the output-voltage level from the movement detection unit 103 is displayed on the display area. If the operator finds that the output-voltage level is low, the operator may move to a location where the output-voltage level is high. Accordingly, the operator finds it easier to control the operation control device 100.

Furthermore, the output-voltage waveform of the movement detection unit 103 is displayed on the display area. This countermeasure permits the operator to confirm a movement which so that a more beautiful waveform can be generated. Consequently, the operator finds it even easier to control the operation control device 100.

Incidentally, instead of the output-voltage waveform of the movement detection unit 103, an image which is easy for the operator to understand may be used as the image for indicating the amplitude of the output-voltage level from the movement detection unit 103. An example of such an image is that a small image is used if the output-voltage level is low; whereas a large image is used if the output-voltage level is high.

Also, instead of displaying the movement detection situation on the display unit 101, an optical element such as LED is deployed in the operation control device 100. Then, by controlling light from the optical element, it becomes possible to let the operator know the movement detection situation. In this case, there exists an effect that the power consumption during the recognition of the operator's movement becomes low, and that the control becomes easier.

### Embodiment 3

Next, the explanation will be given below concerning an embodiment where operations are switched to each other in the operation control device 100 by a movement of the operator. For example, when the operation control device 100 is a television receiver, it would be convenient to switch operation among a set of paired operations or more than two operations, like increasing and decreasing sound volume or increasing and decreasing channel number, by movement of operator instead of up and down operations on a remote controller. In the present embodiment, the explanation will be given selecting, as an example, the sound volume change in the operation control device 100.

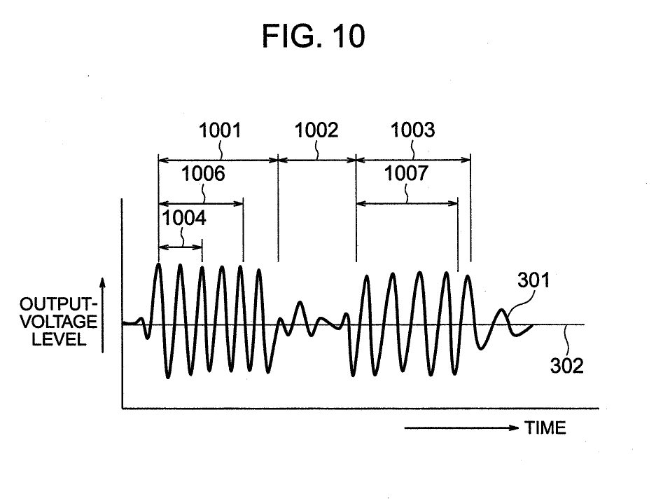

FIG. 10 illustrates an example of the output-voltage waveform of the movement detection unit 103. The same reference numerals are allocated to the same components as the ones in FIG. 3A, FIG. 3B, and FIG. 4, and thus the explanation thereof will be omitted. A time-interval 1001 and a time-interval 1003 are time-intervals during which the operator is doing a continuous movement such as hand-waving. Meanwhile, a time-interval 1002 is a time-interval during which the operator is not doing a continuous movement such as hand-waving.

In the operation control device 100, when, e.g., a control for making the sound volume smaller is performed in the time-interval 1001, if the waveforms whose number is larger than a certain constant exist in the time-interval 1001, and if the time-interval 1002 is shorter than a time-period set in advance, a control for making the sound volume larger is performed in the time-interval 1003. A time-interval 1004 indicates the number of the waveforms which are needed for displaying a control target showing an operation item on the display unit. A time-interval 1006 and a time-interval 1007 indicate the numbers of the waveforms which are needed for actually controlling the operation control device 100.

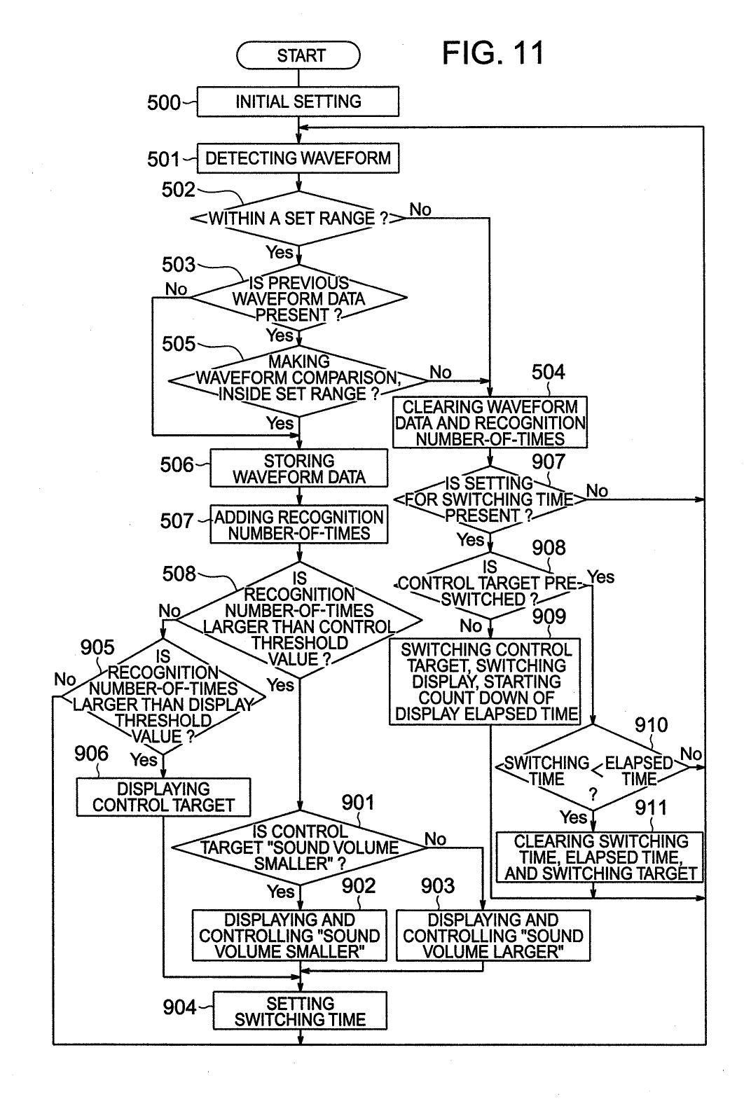

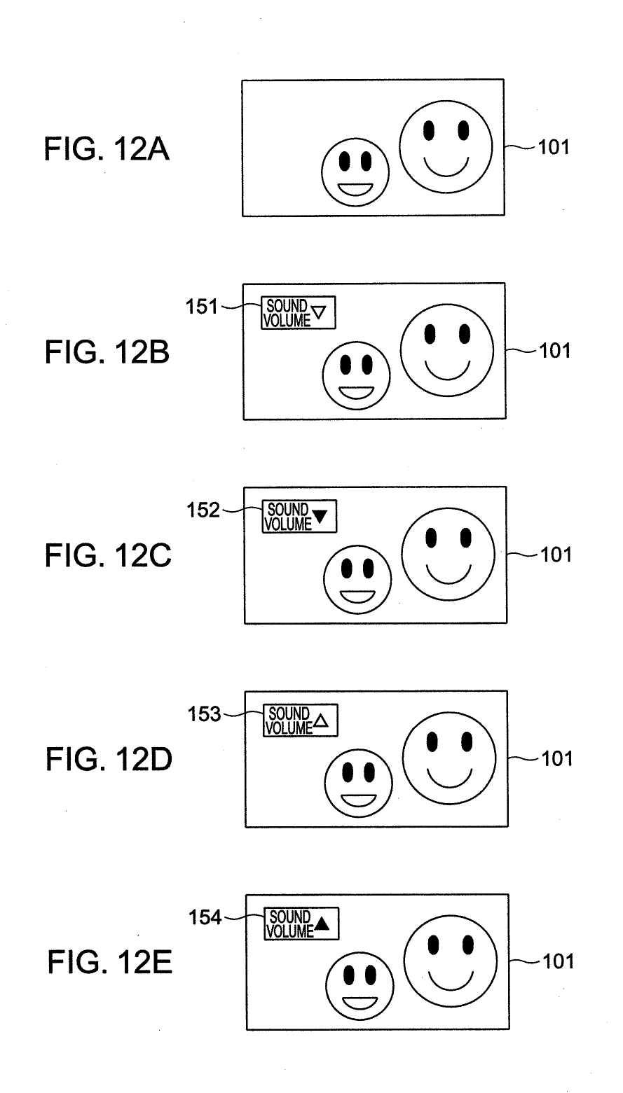

FIG. 11 illustrates an example of the processing flow of the operation control device 100 in the present embodiment. FIGS. 12A to 12E illustrate examples of the display pictures which are to be displayed on the display unit 101 in the case where the output-voltage waveform is the waveform as was explained in FIG. 10. The same reference numerals are allocated to the same components as the ones in FIG. 5, and thus the explanation thereof will be omitted.

First, when the operation control device 100 has not detected the continuous movement of the operator, the display picture of the display unit 101 is in a state where, as illustrated in FIG. 12A, none of the information about the movement detection is displayed. Next, if, at the step 508, the waveform recognition number-of-times is judged to be smaller than the control threshold value, the operation proceeds to a step 905.

If, at the step 905, the waveform recognition number-of-times has exceeded the number of the waveforms which are needed for displaying the control target on the display unit, the control target is displayed at a step 906. A reference numeral 151 in FIG. 12B denotes a control-target display area, on which, e.g., a message for making the sound volume smaller is displayed. At this point-in-time, the control for making the sound volume smaller actually is not performed.

Meanwhile, if, at the step 508, the waveform recognition number-of-times is judged to be larger than the control threshold value, the operation proceeds to a step 901. At the step 901, a control for the operation control device 100, e.g., the control for making the sound volume smaller, is performed. Moreover, an item over which the control has been actually exerted is displayed at a step 902 or a step 903. A numeral 152 in FIG. 12C denotes the control-target display area, on which, e.g., a message for having made the sound volume smaller is displayed. This message is displayed during a certain constant time-period which is long enough for the operator to be able to recognize the message.

Next, at a step 904, the setting for a switching time is performed. Here, the switching time means a maximum await time which elapses from a point-in-time when the operator intentionally stops the continuous movement in order to switch the control target to a point-in-time when the operator starts the next movement.

Here, if the operator stops the continuous movement, the waveform falls outside the constant set range at the step 502. Moreover, the waveform data and recognition number-of-times are cleared at the step 504, and then the operation proceeds to a step 907. At the step 907, if the setting for the switching time is absent, the next waveform analysis is started. Meanwhile, if the setting for the switching time is present, the operation proceeds to a step 908.

If, at the step 908, the control target has been not pre-switched yet, at a step 909, the control target is switched, and the display of the control target is switched. This means that, for example, the display of the message for having made the sound volume smaller, as indicated on the display picture in FIG. 12C, is changed into a message for making the sound volume larger as indicated on a control-target display area 153 in FIG. 12D. Moreover, counting down the display elapsed time is started. At this point-in-time, the control for making the sound volume larger actually is not performed yet. The control for making the sound volume larger actually is performed at the step 903. Also, at the step 903, a display picture for notifying that the sound volume has been made larger is displayed as indicated on a control-target display area 154 in FIG. 12E.

Here, if at the step 908, the control target has been pre-switched already, the operation proceeds to a step 910. If at the step 910, the elapsed time from the step 909 is found to be smaller than the switching time set at the step 904, the operation proceeds to the next waveform analysis. Meanwhile, if the elapsed time is found to be larger than the switching time, the operator is regarded as not having a will to perform the control whose display is underway on the display picture. Namely, the operation proceeds to a step 911, at which the switching time, the elapsed time, and the switching target are restored back into the initial state. Concretely, the picture is cleared which is displayed on the control-target display area 153 in FIG. 12D. This operation changes the picture into the state in FIG. 12A, where none of the control-target display areas is present.

As having been explained so far, in the operation control device 100 in the present embodiment, it becomes possible to switch the two units of control targets to each other on the basis of basically the same movements. Furthermore, in the above-described explanation, the explanation has been given regarding the example where the two control targets are switched to each other. Even the switching for two or more control targets, however, is made implementable by adding a time-interval similar to the time-interval 1003 during which a continuous movement of the operator is performed, and a time-interval similar to the time-interval 1002 during which a continuous movement of the operator is not performed and detecting the operator's movement during such added time-intervals.

### Embodiment 4

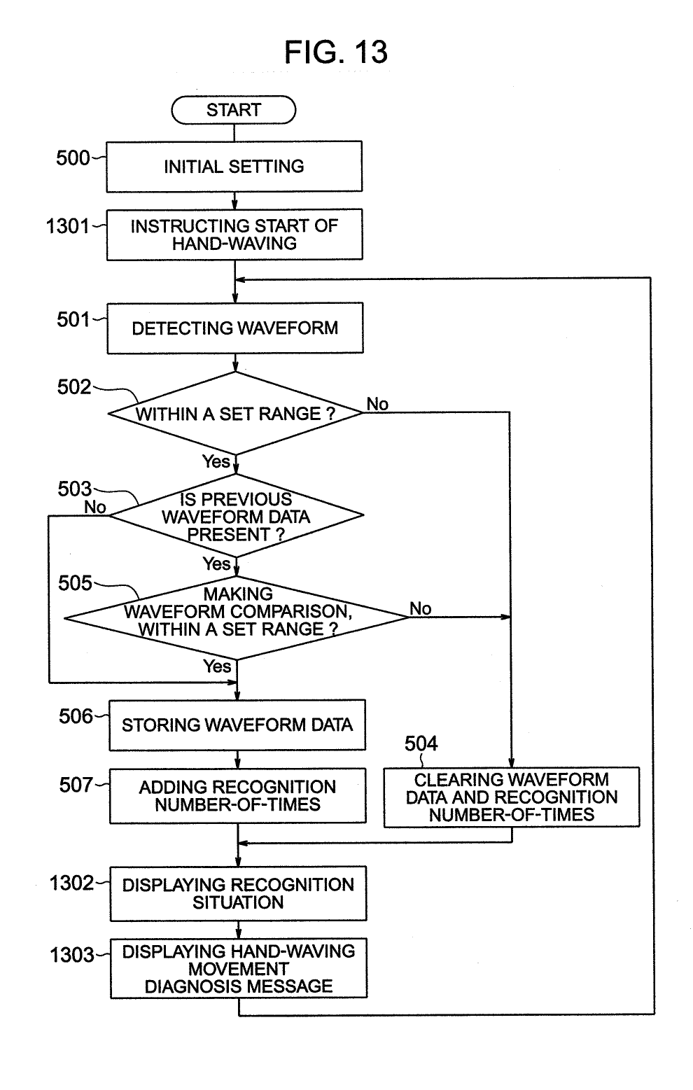

Next, the explanation will be given below concerning an embodiment of the operation control device 100 which is equipped with a mode of allowing the operator to practice a movement for operating the operation control device 100 before actually operating the operation control device 100. FIG. 13 illustrates an example of its processing flow. The same reference numerals are allocated to the same components as the ones in FIG. 5, and thus the explanation thereof will be omitted.

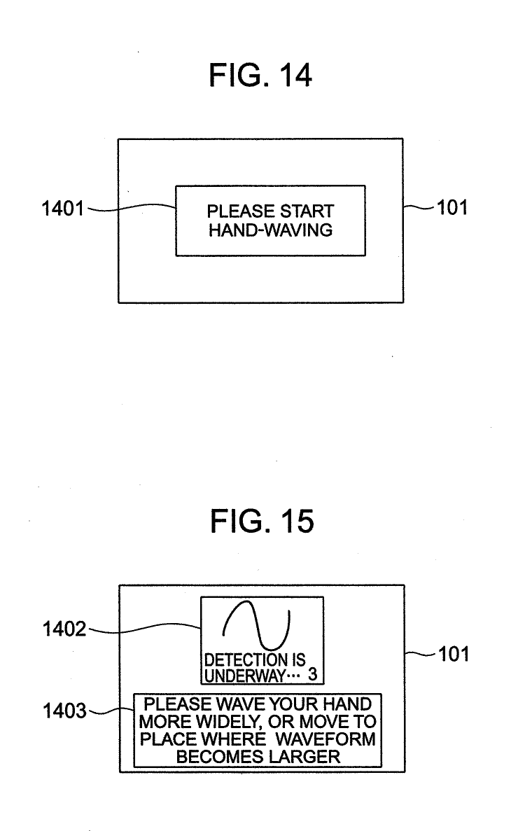

The movement practice mode of the operation control device 100 is started, and the initial setting 500 is over. Then, at a step 1301, the operation control device 100 instructs the operator to start a hand-waving. Referring to FIG. 14, the explanation will be given below regarding an example where the operation control device 100 instructs the operator to start the hand-waving, and which is to be displayed on the display screen 101.

A reference numeral 1401 denotes a message display area for displaying an instruction to be displayed on the display screen 101. The message display area 1401 displays a message for prompting the operator to do a movement, e.g., a message saying “Please start hand-waving.” Incidentally, the notification method from the operation control device 100 is not limited to the example of the display picture in FIG. 14. Namely, a voice may also be used, both of a voice and a message or other notification method may also be used so that the operator can easily notice.

When the operator starts the movement such as a hand-waving, the waveform is analyzed as is the case with the step 501 to the step 507 in FIG. 5. Next, at a step 1302, the waveform recognition situation is displayed. Moreover, at a step 1303, a hand-waving movement diagnosis message is displayed.

FIG. 15 illustrates an example of the display picture which displays thereon the waveform recognition situation and the hand-waving movement diagnosis message. A numeral 1402 denotes a waveform-recognition-situation display area, and a numeral 1403 denotes a hand-waving movement diagnosis message area. The waveform-recognition-situation display area 1402 displays the output-voltage level from the movement detection unit 103 in a manner of the waveform representation, and further, displays the number of the waveforms detected as the waveforms. In the hand-waving movement diagnosis message area 1403, if the amplitude of the waveforms is small, the operator is prompted to wave his or her hand more widely, or is prompted to displace to a position at which the sensitivity of the operation control device 100 is higher. This prompting process makes larger the amplitude of the output-voltage level from the movement detection unit 103, so that the operator finds it easier to recognize his or her hand-waving movement for intending the control over the operation control device 100 without fail.

In addition, for example, if the hand-waving movement is too fast, and thus the waveforms cannot be created well, or if the hand-waving movement is too slow, and thus the hand-waving movement is likely to be mistaken for another movement, a message such as “Please make hand-waving a little slower.”, or “Please make hand-waving a little faster.” is displayed on the hand-waving movement diagnosis message area 1403.

As having been explained above, the operation learning mode allows the operator to learn a movement or position in which the operator finds it easier to recognize an operation such as hand-waving movement. Consequently, it becomes possible for the operator to control the operation control device 100 more easily.

Incidentally, in the above-described description, the explanation of the operation control device 100 has been given in a manner of being divided into its first to fourth embodiments. The respective embodiments, however, can be combined with each other depending on the requirements. For example, the plurality of controls explained in each embodiment may be accomplished by a single device.

It should be further understood by those skilled in the art that although the foregoing description has been made on embodiments of the invention, the invention is not limited thereto and various changes and modifications may be made without departing from the spirit of the invention and the scope of the appended claims.

1. An information processing device, comprising:
a movement detection unit for detecting a movement of a user; and
a movement analysis unit for analyzing a detection result by said movement detection unit, wherein
said movement analysis unit is configured to:
analyze an elapsed-time change in said movement of said user detected by said movement detection unit; and
perform a predetermined processing in said information processing device if said elapsed-time change in said movement of said user has exceeded a predetermined threshold value.

2. The information processing device according to claim 1, wherein
said movement detection unit is configured to output a voltage corresponding to said movement of said user by detecting a change in heat radiation amount emitted from said user, and,
said movement analysis unit is configured to analyze said elapsed-time change in said movement of said user based on an elapsed-time change in said voltage outputted from said movement detection unit.

3. The information processing device according to claim 2, wherein,
said movement analysis unit is configured to analyze whether or not said user has repeated a predetermined operation at a predetermined number-of-times based on said elapsed-time change in said voltage outputted from said movement detection unit.

4. The information processing device according to claim 1, wherein
said movement detection unit is comprised of a pyroelectric infrared-rays sensor.

5. The information processing device according to claim 2, wherein
said movement analysis unit is configured to:
extract waveforms having amplitudes of said waveforms being larger than a predetermined amplitude from said elapsed-time change in said voltage outputted from said movement detection unit; and
perform said predetermined processing if the waveforms have been continuously extracted more than a predetermined number of waveforms.

6. The information processing device according to claim 1, wherein
said predetermined processing is changed depending on the state of said information processing device.

7. The information processing device according to claim 1, wherein
said predetermined processing is set by said user.

8. The information processing device according to claim 1, further comprising:
a display unit for displaying an image,
said analysis result by said movement analysis unit being displayed on said display unit.

9. The information processing device according to claim 8, wherein
said display of said analysis result by said movement analysis unit is performed before said predetermined processing is performed.

10. The information processing device according to claim 1, wherein,
after said elapsed-time change in said movement of said user has exceeded said predetermined threshold value, said elapsed-time change being analyzed by said movement analysis unit,
said movement analysis unit switches said predetermined processing into another processing if said movement analysis unit detects that said elapsed-time change in said movement of said user has become smaller than said predetermined threshold value,

11. The information processing device according to claim 1, wherein
said analysis result by said movement analysis unit and a message which instructs said user to do a movement in correspondence with said analysis result are displayed.
